(19) United States
(12) Patent Application Publication
(10) Pub. No.: US 2009/0243222 A1
(43) Pub. Date: Oct. 1, 2009

(54) Sealing arrangement for a gas turbine

(76) Inventor: Arnaud Pisseloup, Berlin (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 12/379,379

(22) Filed: Feb. 19, 2009

(30) Foreign Application Priority Data
Feb. 19, 2008 (DE) 10 2008 009 824.8

(51) Int. Cl. F16J 15/44; F02C 7/28

(52) U.S. Cl. 277/422

(57) ABSTRACT

A sealing arrangement includes a radially inner first part 1 and a radially outer second part 2a, 2b, which are rotatable relative to each other about a common rotary axis 3. The first part 1 and the second part 2a, 2b are radially spaced to each other forming a gap 4. One of the parts 1, 2 includes a radial groove 5 in which a sealing ring 6 sealing the gap 4 is arranged. The sealing ring 6 is provided with at least one pressure compensation hole 7.

This application claims priority to German Patent Application DE102008009824.8 filed Feb. 19, 2008, the entirety of which is incorporated by reference herein.

The present invention relates to a sealing arrangement.

More particularly, the present invention relates to a sealing arrangement which, in particular, is used for sealing a bearing chamber of a gas turbine.

With gas turbines, it is known to provide a sealing ring in the bearing chamber to seal an area of the bearing chamber containing air and oil against an external area with air of higher pressure.

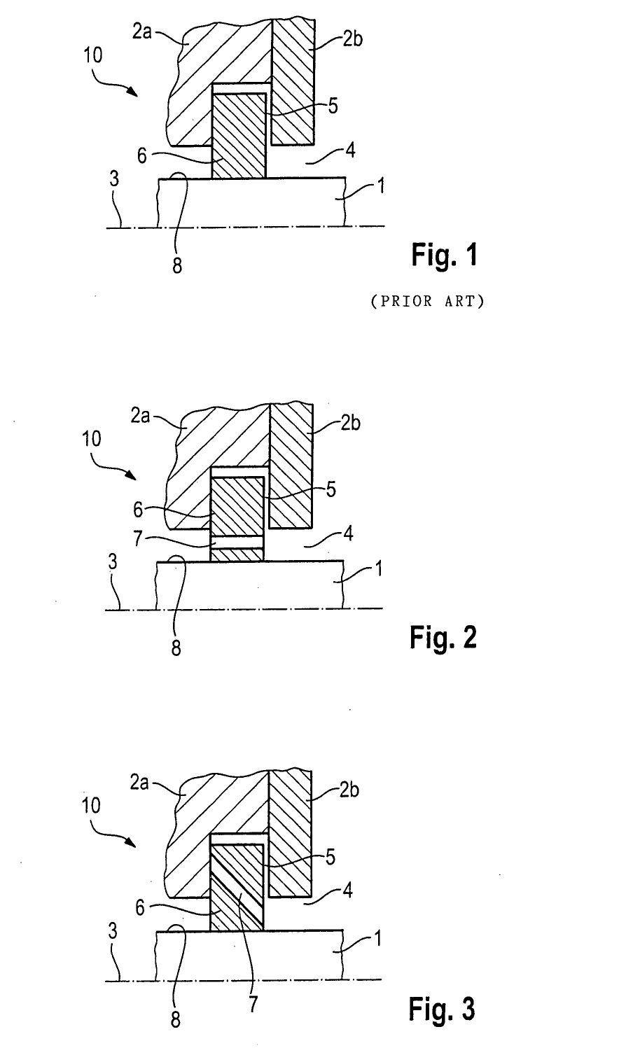

The state of the art (see FIG. 1) here provides for the use of a split or one-piece sealing ring 6 which is located on a radially inner first part 1 (shaft) rotating about a rotary axis 3. The sealing ring 6 is slightly moveable in the axial ring and is retained in a radial groove 5 disposed in a second, radially outer part 2a, 2b.

Such seals for bearing chambers are usually provided with a sealing ring, additionally a labyrinth seal may be provided.

A small, annular gap 4 exists between the second part 2a, 2b and the first part 1.

With regard to the aforementioned labyrinth seal, provision of an additional labyrinth seal in conjunction with the sealing ring may be problematic under certain design conditions. Therefore, a preferential arrangement includes one sealing ring on each side of the bearing chamber. However, if the air pressure (right-hand side in FIG. 1) exceeds the internal pressure of the bearing chamber (left-hand side in FIG. 1), the sealing ring 6 may contact and even firmly adhere to the inner flange of the sealing carrier (second part 2a, 2b). The reason for this is the high pressure difference (pressure differential) between the right-hand and the left-hand side of the sealing arrangement according to FIG. 1. If the sealing ring 6 firmly adheres to the wall of the radial groove 5, the sealing ring 6 is stopped or substantially hindered from rotating freely. This entails considerable wear on the inner radius area of the sealing ring 6 fitted to the shaft (first part 1). Consequently, the sealing ring 6 is subject to wear. Furthermore, sealing efficiency is considerably reduced.

It is a broad aspect of the present invention to provide a sealing arrangement of the type specified at the beginning, which while being simply designed and featuring good sealing efficiency, can be manufactured easily and cost-effectively and avoids the disadvantages of the state of the art.

In accordance with the present invention, it is therefore provided that either the sealing ring or the radially outer part features at least one pressure compensation hole. With the pressure difference across the sealing ring thus being reduced, the total force acting upon the sealing ring will not be sufficient to keep it in permanent contact with the flange (surface of the radial groove). This ensures that the sealing ring will not contact the outer part and/or adhere to it under high friction. Consequently, wear of the sealing ring is considerably reduced.

According to the present invention, the pressure compensation hole can be provided in the axial direction. However, the pressure compensation hole can also be inclined relative to the rotary axis to feed air directly to the side wall of the sealing ring which is in contact with the radial groove. An air bearing is thus provided on which the sealing ring slides. Consequently, static oil losses are avoided since no oil flow can occur when the sealing arrangement is at rest.

In accordance with the present invention, it has shown to be particularly favorable if several pressure compensation holes are equally distributed on the circumference. The preferred minimum number of pressure compensation holes is four, with the holes being preferably offset by 90° C. to each other. Thus, freedom of movement of the sealing ring is ensured.

The pressure compensation holes are preferably dimensioned for the passage of a minimum and a maximum airflow. This dimensioning of the pressure compensation holes enables the airflow entering the bearing chamber to be exactly determined and, consequently, an oil scavenge pump and/or a vent line to be also optimally sized. This results in further cost benefits for the overall bearing arrangement.

The present invention therefore provides for the implementation of a principle in which sealing air flows through the pressure compensation holes. This sealing air provides for an air pressure in the radial groove or annular groove which approximates the pressure in the bearing chamber, resulting, on the whole, in a lower differential pressure in the sealing ring. As mentioned above, this prevents the sealing ring from contacting or adhering to the wall of the radial groove or the annular groove, as were the case with a large pressure difference. Thus, wear of the sealing ring is considerably reduced.

The present invention is more fully described in light of the accompanying drawing showing preferred embodiments. In the drawing,

FIG. 1 (Prior Art) shows a sealing arrangement in accordance with the state of the art,

FIG. 2 shows a sealing arrangement, analogically to FIG. 1, of a first embodiment of the present invention,

FIG. 3 shows a sealing arrangement of a further embodiment of the present invention, and

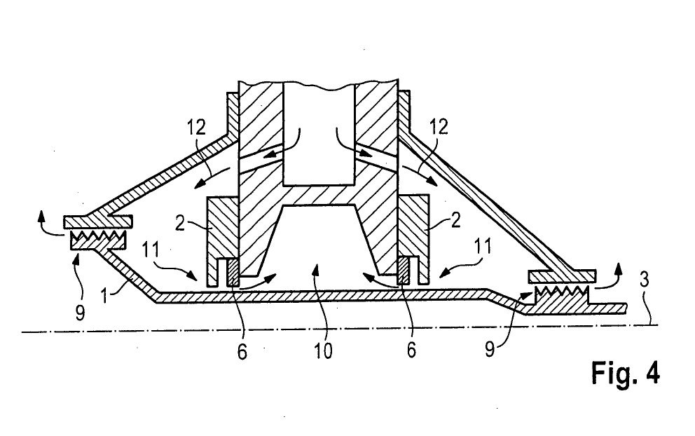

FIG. 4 is a schematic representation of the sealing arrangement in accordance with the present invention, in association with a bearing chamber.

The Figures each show a radially inner first part 1 in the form of a shaft rotatable about a rotary axis 3. Arranged on a surface 8 of the first part 1 is a sealing ring 6, which is located and held in a radial groove 5 (annular groove) of a radially outer second part 2a, 2b. The radial groove 5 is radially dimensioned larger than the sealing ring 6, enabling the latter to slightly move in the axial direction. This ensures that the sealing ring 6 slides in the radial groove 5, while being non-rotationally fitted to the first part 1.

In the Figures, the zone of bearing air is shown on the right-hand side and the area associated to the bearing chamber (oil/air) on the left-hand side, with the pressure on the right-hand side exceeding that on the left-hand side.

In the embodiment shown in FIG. 2, at least one radial pressure compensation hole 7 is provided in the sealing ring. This leads to a decrease of the pressure difference across the sealing ring and reduces the hazard that the sealing ring contacts the wall of the radial groove 5 and co-rotates with the radially outer second part 2a, 2b, thereby suffering wear on the surface 8 of the first part 1.

FIG. 3 shows a further embodiment in which the pressure compensation hole 7 is axially inclined. Accordingly, the bearing air is fed to the flank of the sealing ring 6 and forms, together with the wall of the radial groove 5, an air bearing providing for wear-free location and fixation of the sealing ring 6 in the radial groove 5.

FIG. 4 shows the sealing arrangement in accordance with the present invention in association with a bearing chamber 10. Illustration of the bearing itself was dispensed with. FIG. 4 shows, in particular, the application of bearing air 12 to the sealing ring 6 from a central supply via the two sideward areas of the sealing arrangement in accordance with the present invention. In FIG. 4, the sealing arrangement is indicated with the reference numeral 11. FIG. 4 further shows that the bearing air 12 also escapes laterally through the labyrinth seals 9, as known from the state of the art.

### LIST OF REFERENCE NUMERALS

1 Radially inner first part
2 Radially outer second part
3 Rotary axis
4 Gap
5 Radial groove
6 Sealing ring
7 Pressure compensation hole
8 Surface
9 Labyrinth seal
10 Bearing chamber
11 Sealing arrangement (annular seal)
12 Bearing air

What is claimed is:

1. A sealing arrangement, comprising:
a radially inner first part;
a radially outer second part, the first and second parts being rotatable relative to each other about a common rotary axis, the first part and the second part also being radially spaced from each other to form a gap, one of the parts including a radial groove; and
a sealing ring positioned in the groove for sealing the gap;
wherein, the sealing ring includes at least one pressure compensation hole.

2. The sealing arrangement of claim 1, wherein the pressure compensation hole is essentially arranged in an axial direction.

3. The sealing arrangement of claim 1, wherein the pressure compensation hole is inclined towards an axial direction.

4. The sealing arrangement of claim 1, comprising a plurality of pressure compensation holes circumferentially arranged around the sealing ring.

5. The sealing arrangement of claim 4, comprising at least four pressure compensation holes circumferentially arranged around the sealing ring.

6. The sealing arrangement of claim 1, wherein the pressure compensation hole is dimensioned relative to a bearing airflow.

7. The sealing arrangement of claim 4, wherein the plurality of pressure compensation holes are dimensioned relative to a bearing airflow.

8. The sealing arrangement of claim 1 in a bearing chamber of a gas turbine.

9. A sealing arrangement, comprising:
a radially inner first part;
a radially outer second part, the first and second parts being rotatable relative to each other about a common rotary axis, the first part and the second part also being radially spaced from each other to form a gap, one of the parts including a radial groove; and
a sealing ring positioned in the groove for sealing the gap;
wherein, the second part includes at least one pressure compensation hole.

10. The sealing arrangement of claim 9, wherein the pressure compensation hole is essentially arranged in an axial direction.

11. The sealing arrangement of claim 9, wherein the pressure compensation hole is inclined towards an axial direction.

12. The sealing arrangement of claim 9, comprising a plurality of pressure compensation holes circumferentially arranged around the second part.

13. The sealing arrangement of claim 12, comprising at least four pressure compensation holes circumferentially arranged around the second part.

14. The sealing arrangement of claim 9, wherein the pressure compensation hole is dimensioned relative to a bearing airflow.

15. The sealing arrangement of claim 12, wherein the plurality of pressure compensation holes are dimensioned relative to a bearing airflow.

16. The sealing arrangement of claim 9 in a bearing chamber of a gas turbine.
